(19) United States
(12) Patent Application Publication
(10) Pub. No.: US 2024/0027589 A1
(43) Pub. Date: Jan. 25, 2024

(54) RANGE FINDING DEVICE AND CONTROL METHOD THEREFOR

(71) Applicant: CANON KABUSHIKI KAISHA, Tokyo (JP)

(72) Inventor: Ayumu NEMOTO, Tokyo (JP)

(21) Appl. No.: 18/353,197

(22) Filed: Jul. 17, 2023

(30) Foreign Application Priority Data
Jul. 21, 2022 (JP) 2022-116576

(51) Int. Cl. G01S 7/4863; G01S 7/4865; G01S 17/89; G01S 17/10

(52) U.S. Cl. CPC G01S 7/4863; G01S 7/4865; G01S 17/89; G01S 17/10

(57) ABSTRACT

A range finding device comprising an image sensor and a measurement circuit that measures a distance to a predetermined position within a field of view of the image sensor based on time of flight of light, is disclosed. The range finding device records image data that has been obtained using the image sensor, as well as a measurement result from the measurement circuit, into a recording medium in association with each other. The range finding device executes the recording under a condition that the measurement performed by the measurement circuit has been successful.

### BACKGROUND OF THE INVENTION

### Field of the Invention

The present invention relates to a range finding device and a control method therefor, and especially to a range finding device that has an image capture function and a control method therefor.

### Description of the Related Art

Conventionally, there is a known range finding device that measures a distance to an object that has reflected light based on a period from emission of the light to detection of the reflected light (Japanese Patent Laid-Open No. 2014-115191). Also, the range finding device described in Japanese Patent Laid-Open No. 2014-115191 can display and record an image in which the emission position of infrared light, which cannot be confirmed with the naked eye, has been visualized together with a measured distance, with use of an image sensor that can capture images of infrared light and visible light.

In some cases, reflected light with the intensity required for measurement cannot be obtained due to, for example, the shape of and the distance to an object; therefore, a range finding device that is based on detection of reflected light is not always capable of obtaining a ranging result. Furthermore, there are also cases where, in order to confirm the accuracy of a ranging result, ranging is performed several times with respect to the same position or nearby positions.

Meanwhile, according to the range finding device described in Japanese Patent Laid-Open No. 2014-115191, once an instruction for recording images has been issued by operating a recording operation unit, images are recorded continuously until an instruction for stopping recording is issued. This may result in recording of images for which ranging results have not been obtained, and images related to ranging that has been performed multiple times with respect to the same position or nearby positions. Therefore, it is not easy for a user to find desired images after recording.

### SUMMARY OF THE INVENTION

The present invention provides, in one aspect thereof, a range finding device that can efficiency record an image useful for a user, and a control method therefor.

According to an aspect of the present invention, there is provided a range finding device, comprising: an image sensor; a measurement circuit that measures a distance to a predetermined position within a field of view of the image sensor based on time of flight of light; and a control circuit that records image data that has been obtained using the image sensor, as well as a measurement result from the measurement circuit, into a recording medium in association with each other, wherein the control circuit executes the recording under a condition that the measurement performed by the measurement circuit has been successful.

According to another aspect of the present invention, there is provided a range finding device, comprising: an image capture device including an image capture optical system and an image sensor; a measurement circuit that measures a distance to a predetermined position within a field of view of the image capture device; a focus adjustment circuit that performs focus adjustment with respect to the image capture optical system; and a control circuit that records image data that has been obtained using the image capture device, as well as a measurement result from the measurement circuit, into a recording medium in association with each other, wherein the control circuit executes the recording under a condition that the measurement performed by the measurement circuit has been successful, and in a case where the measurement performed by the measurement circuit has not been successful, the recording is not executed even if the focus adjustment has been successful.

According to further aspect of the present invention, there is provided a control method for a range finding device that includes an image sensor and a measurement circuit that measures a distance to a predetermined position within a field of view of the image sensor based on time of flight of light, the control method comprising recording image data that has been obtained using the image sensor, as well as a measurement result from the measurement circuit, into a recording medium in association with each other under a condition that the measurement performed by the measurement circuit has been successful.

According to another aspect of the present invention, there is provided a control method for a range finding device that includes an image capture device including an image capture optical system and an image sensor, a measurement circuit that measures a distance to a predetermined position within a field of view of the image capture device, and a focus adjustment circuit that performs focus adjustment with respect to the image capture optical system, the control method comprising: recording image data that has been obtained using the image capture device, as well as a measurement result from the measurement circuit, into a recording medium in association with each other under a condition that the measurement performed by the measurement circuit has been successful; and in a case where the measurement performed by the measurement circuit has not been successful, refraining from executing the recording even if the focus adjustment has been successful.

According to another aspect of the present invention, there is provided a non-transitory computer-readable medium storing a program executable by a computer being included in a range finding device that comprises an image sensor and a measurement circuit that measures a distance to a predetermined position within a field of view of the image sensor based on time of flight of light, wherein the program causes, when executed by the computer, the computer to record image data that has been obtained using the image sensor, as well as a measurement result from the measurement circuit, into a recording medium in association with each other under a condition that the measurement performed by the measurement circuit has been successful.

According to a further aspect of the present invention, there is provided a non-transitory computer-readable medium storing a program executable by a computer being included in a range finding device that includes an image capture device including an image capture optical system and an image sensor, a measurement circuit that measures a distance to a predetermined position within a field of view of the image capture device, and a focus adjustment circuit that performs focus adjustment with respect to the image capture optical system, wherein the program causes, when executed by the computer, the computer to perform a control method for the range finding device comprising: recording image data that has been obtained using the image capture device, as well as a measurement result from the measurement circuit, into a recording medium in association with each other under a condition that the measurement performed by the measurement circuit has been successful; and in a case where the measurement performed by the measurement circuit has not been successful, refraining from executing the recording even if the focus adjustment has been successful.

Further features of the present invention will become apparent from the following description of exemplary embodiments (with reference to the attached drawings).

### BRIEF DESCRIPTION OF THE DRAWINGS

FIG. 1 is a perspective view showing an exemplary external view of a range finding device according to an embodiment.

FIG. 2 is a block diagram showing an exemplary functional configuration of the range finding device according to an embodiment.

FIGS. 3A and 3B are diagrams showing examples of images displayed by the range finding device according to an embodiment.

FIG. 4 is a flowchart related to the operations in a simultaneous recording mode of the range finding device according to an embodiment.

FIG. 5 is a flowchart related to the operations in the simultaneous recording mode of the range finding device according to an embodiment.

FIGS. 6A to 6C are flowcharts related to the operations in the simultaneous recording mode of the range finding device according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

The present invention can be implemented on any electronic device that can be provided with a range finding function that measures a distance to an object based on the time of flight (ToF) of light, and an image capture function. Such an electronic device includes a digital camera, a computer device (e.g., a personal computer, a tablet computer, a media player, and a PDA), a mobile telephone device, a smartphone, a game device, a robot, a drone, and a driving recorder. These are examples, and the present invention can be implemented on other electronic devices.

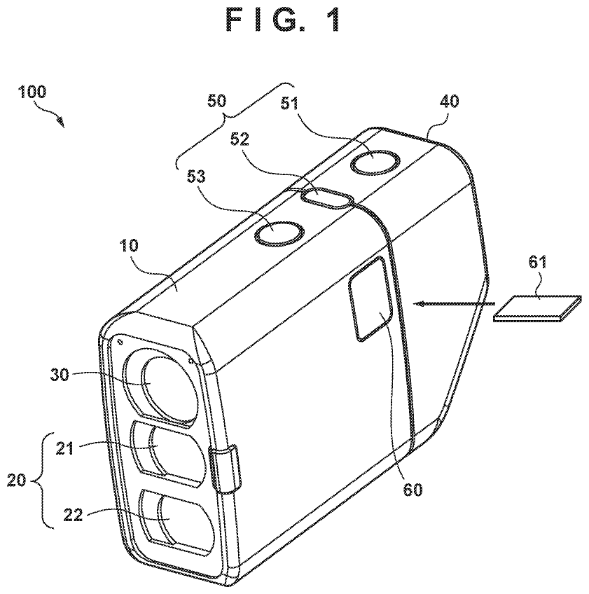

FIG. 1 is perspective view showing exemplary external view of a range finding device 100 according to an embodiment of the present invention. The range finding device 100 includes a main body 10 and an eyepiece unit 40, and the main body 10 includes a range finding unit 20, a shooting unit 30, and a recording medium I/F 60. Note that in a case where an attachable/removable recording medium 61 is not used, the recording medium I/F 60 may not be provided. Furthermore, an operation unit 50 including a plurality of input devices 51 to 53 is provided on an outer surface of the range finding device 100.

The range finding unit 20 measures a distance between the range finding device 100 and an object that has reflected laser light based on a time difference between emission of laser light from a light emitting unit 21 and detection of the reflected light in a light receiving unit 22, that is to say, the time of flight (ToF) of light.

The shooting unit 30 includes an image capture optical system and an image sensor, and generates image data indicating an image of a subject included in a field of view with a predetermined angle of view. Note that the light emitting unit 21 has been adjusted to emit laser light in a predetermined direction within the field of view of the shooting unit 30.

The eyepiece unit 40 includes a display device, such as a transmissive liquid crystal panel, inside thereof. Continuously executing the shooting of a moving image by the shooting unit 30 and the display of the captured moving image on the display device inside the eyepiece unit 40 enables the display device to function as an electronic viewfinder (EVF). The moving image that is shot and displayed in order to cause the display device to function as the EVF is referred to as a live-view image.

The user can issue an instruction for executing ranging and shooting by operating an execution button 51 while viewing an image displayed on the display device inside the eyepiece unit 40. One of more images showing a measured distance, information of the range finding device 100, and the like can be superimposed and displayed over the live-view images.

The operation unit 50 includes input devices (e.g., switches, buttons, touch panels, dials, and joysticks) that can be operated by the user. The input devices have names corresponding to the functions assigned thereto. FIG. 1 shows an execution button 51, a power source button 52, and a mode switching button 53. However, these are merely examples. The number and types of the input devices, as well as the functions assigned to the respective input devices, are not limited to these.

The recording medium I/F 60 houses the attachable/removable recording medium 61, such as a memory card. The recording medium 61 housed in the recording medium I/F 60 can communicate with the range finding device 100 via the recording medium I/F 60. The recording medium 61 is used as a recording destination of image data shot by the shooting unit 30. Furthermore, image data recorded in the recording medium 61 can be read out and displayed on a display apparatus inside the eyepiece unit 40. Note that a recording medium that is built in the range finding device 100 may be provided in place of the attachable/removable recording medium 61, or separately from the attachable/removable recording medium 61.

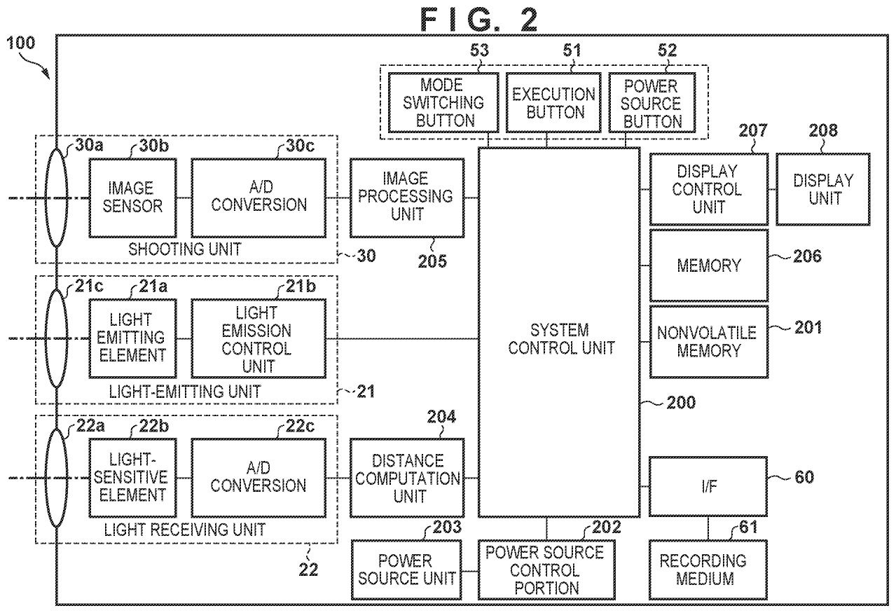

FIG. 2 is a block diagram showing an exemplary functional configuration of the range finding device 100. A system control unit 200 is, for example, one or more processors (a CPU, an MPU, a microprocessor, and the like) that can execute a program. The system control unit 200 controls the operations of each component of the range finding device 100 and realizes the functions of the range finding device 100 by reading a program stored in a nonvolatile memory 201 into a memory 206 and executing the program.

The system control unit 200 executes automatic exposure control (AE) and automatic focus detection (AF) using evaluation values generated by a later-described image processing unit 205. The system control unit 200 determines exposure conditions (an f-number, an exposure period (a shutter speed), and shooting sensitivity) based on an evaluation value for AE, a preset exposure condition (e.g., a program line chart), user settings, and so forth. The system control unit 200 controls the operations of a diaphragm, a shutter (including an electronic shutter), and the like in accordance with the determined exposure conditions. Furthermore, the system control unit 200 causes a shooting optical system to focus on a focus detection region by driving a focusing lens included in the shooting optical system based on an evaluation value for AF.

The nonvolatile memory 201 may be electrically erasable and recordable. The nonvolatile memory 201 stores, for example, a program executed by the system control unit 200, various types of setting values of the range finding device 100, and GUI data of, for example, an image to be superimposed over a menu screen and live-view images.

The memory 206 is used to read in a program executed by the system control unit 200, and temporarily store a measured distance, image data, and the like. Furthermore, a part of the memory 206 is used as a video memory for storing image data for display. As a result of storing a composite image generated from a live-view image and an image showing additional information, such as a measured distance, into the video memory, the image showing the additional information can be superimposed and displayed over the live-view image on the display unit 208.

A power source control unit 202 detects the type of a power source attached to a power source unit 203 (a battery and/or an external power source), and the type and the remaining level of a loaded battery. Furthermore, the power source control unit 202 supplies power required by each block, including the recording medium 61, based on a detection result related to the power source unit 203 and control performed by the system control unit 200. The power source unit 203 is a battery and/or an external power source (e.g., an AC adapter).

The light emitting unit 21, the light receiving unit 22, and a distance computation unit 204 constitute the later-described range finding unit 20 that measures a distance to a predetermined position within the field of view of the shooting unit 30. The light emitting unit 21 includes a light emitting element 21a, a light emission control unit 21b, and an emission lens 21c. The light emitting element 21a is, for example, a semiconductor laser element (laser diode) or the like, and outputs invisible near-infrared light here.

The light emission control unit 21b controls the operations of the light emitting element 21a so as to output pulsed laser light based on a control signal from the system control unit 200. The laser light output from the light emitting element 21a is collected by the emission lens 21c, and then output from the range finding device 100.

The light receiving unit 22 includes a light receiving lens 22a, a light receiving element 22b, and a A/D converter 22c. The light receiving unit 22 detects reflected light of the laser light output from the light emitting unit 21. The light receiving lens 22a collects incident light on a light receiving surface of the light receiving element 22b. The light receiving element 22b is, for example, a photodiode. By way of photoelectric conversion, the light receiving element 22b outputs a received light signal (an analog signal) with an intensity corresponding to the amount of incident light.

The received light signal (analog signal) output from the light receiving element 22b is converted into a digital signal by the A/D converter 22c. The A/D converter 22c outputs the digital signal to the distance computation unit 204.

Note that in a case where the light receiving element 22b is an avalanche photodiode (APD), a numerical value (a digital value) corresponding to the amount of received light is obtained by counting the number of pulses output from the APD, and thus the A/D converter 22c is not necessary.

The distance computation unit 204 measures a distance to an object that has reflected the laser light based on a time of flight (ToF) of a light, that is a period from outputting of the laser light by the light emitting element 21a to detection of the reflected light in the light receiving element 22b. Note that reflected light of the laser light is not always detectable in the light receiving unit 22 depending on a distance to an object that exists in the traveling direction of the laser light, the state of the surface of the object, and so forth. For example, the distance computation unit 204 cannot measure the distance to the object in a case where the light receiving unit 22 has not detected the reflected light within a predetermined period, or in a case where the light receiving unit 22 cannot detect the reflected light appropriately, such as in a case where the intensity of the detected reflected light is weak.

The distance computation unit 204 outputs to the system control unit 200 the measured distance in a case where the distance has been successfully measured. The distance computation unit 204 outputs to the system control unit 200 information indicating a measurement failure in a case where the measurement of the distance has failed. Note that the distance computation unit 204 may output, as a measured distance, a distance that cannot be obtained normally, such as a distance of 0, as information indicating a measurement failure.

The shooting unit 30 includes an image capture optical system 30a, an image sensor 30b, and a A/D converter 30c. The image capture optical system typically includes a plurality of lenses. The plurality of lenses include a focusing lens for adjusting the focusing distance of the shooting optical system Furthermore, the plurality of lenses include a zoom lens in a case where the focal length of the image capture optical system 30a is variable, and a shift lens in a case where an image blur correction function based on lens shifting is provided.

The image sensor 30b may be, for example, a known CCD or CMOS color image sensor that includes color filters of the primary-color Bayer arrangement. The image sensor 30b includes a pixel array in which a plurality of pixels are arranged two-dimensionally, and peripheral circuits for reading out signals from the respective pixels. By way of photoelectric conversion, each pixel accumulates charges corresponding to the amount of incident light. As a result of reading out, from each pixel, a signal having a voltage corresponding to the amount of charges accumulated in an exposure period, a group of pixel signals (analog image signals) indicating a subject image formed by the image capture optical system 30a on an image capture surface is obtained. The operations of the shooting unit 30, such as shooting and adjustment of the focusing distance, are controlled by the system control unit 200.

The A/D converter 30c applies A/D conversion to the analog image signals output from the image sensor 30b, thereby converting them into digital image signals (image data). The image data output from the A/D converter 30c is output to the image processing unit 205.

The image processing unit 205 applies preset image processing to the image data output from the A/D converter 30c, thereby generating signals and image data that suit the intended use, and obtaining and/or generating various types of information. The image processing unit 205 may be, for example, a dedicated hardware circuit, such as an application specific integrated circuit (ASIC), that has been designed to realize specific functions. Alternatively, the image processing unit 205 may be configured to realize specific functions as a result of execution of software by a processor, such as a digital signal processor (DSP) and a graphics processing unit (GPU). The image processing unit 205 outputs the information and data that have been obtained or generated to the system control unit 200.

The image processing applied by the image processing unit 205 to the image data can include, for example, preprocessing, color interpolation processing, correction processing, detection processing, data editing processing, evaluation value calculation processing, special effects processing, and so forth.

The preprocessing can include signal amplification, reference level adjustment, defective pixel correction, and so forth.

The color interpolation processing is executed in a case where color filters are provided in the image sensor 30b, and is processing for interpolating the values of color components that are not included in individual pieces of pixel data that compose the image data. The color interpolation processing is also referred to as demosaicing processing.

The correction processing can include such processing as white balance adjustment, tone correction, correction of image deterioration caused by optical aberration of the image capture optical system 30a (image restoration), correction of the influence of vignetting of the image capture optical system 30a, and color correction.

The detection processing can include detection of a feature region (e.g., a face region or a human body region) and a motion therein, processing for recognizing a person, and so forth. The data editing processing can include such processing as cutout (cropping) of a region, composition, scaling, encoding and decoding, and generation of header information (generation of a data file). The data editing processing also includes generation of image data for display and image data for recording.

The evaluation value calculation processing can include processing for generating signals and an evaluation value used in automatic focus detection (AF), generating an evaluation value used in automatic exposure control (AE), and so forth.

The special effects processing can include, for example, processing for adding blur effects, changing colors, relighting, and so forth.

Note that these are examples of processing that can be applied by the image processing unit 205 to the image data; the image processing unit 205 need not apply all of them, and may apply other types of processing.

The system control unit 200 stores image data output from the image processing unit 205 into the memory 206. The system control unit 200 stores image data for display into a video memory region of the memory 206. Furthermore, the system control unit 200 generates image data indicating information to be superimposed and displayed over live-view images, such as a measured distance obtained from the distance computation unit 204, and stores the generated image data into the video memory region of the memory 206.

Based on image data stored in the video memory region of the memory 206, a display control unit 207 generates a display signal of a format that is appropriate for the display unit 208, and outputs the display signal to the display unit 208. The display unit 208 is a display apparatus, such as a liquid crystal display apparatus, disposed inside the eyepiece unit 40.

Operations on the input devices included in the operation unit 50 are monitored by the system control unit 200. The system control unit 200 executes a preset operation in accordance with the type of the input device that has been operated and the timing of the operation.

When an operation on the execution button 51 has been detected, the system control unit 200 executes recording of an image captured by the shooting unit 30, measurement of a distance with use of the range finding unit 20, and so forth.

When an operation on the power source button 52 has been detected, the system control unit 200 switches between power-ON and power-OFF of the range finding device 100.

When an operation on the mode switching button 53 has been detected, the system control unit 200 switches among operation modes of the range finding device 100. It is assumed that the range finding device 100 includes a shooting mode, a range finding mode, and a simultaneous recording mode as the operation modes.

In a case where an operation on another input device included in the operation unit 50, such as a direction key and a menu button, has been detected, the system control unit 200 executes a preset operation in accordance with the type of the input device that has been operated and the timing of the operation. For example, in a case where an operation on the menu button has been detected, the system control unit 200 causes the display unit 208 to display a GUI for a menu screen. When an operation on the direction key has been detected in a state where the menu screen is displayed, the system control unit 200 changes a selected item on the menu screen in accordance with the direction key that has been operated. Furthermore, when an operation on the execution button 51 has been detected in a state where the menu screen is displayed, the system control unit 200 changes the settings in accordance with an item in a selected state, or causes a transition to another menu screen.

The shooting mode is a mode in which an operation on the execution button 51 is regarded as an instruction for starting or stopping recording. When the range finding device 100 is placed in a power-ON state, the system control unit 200 executes an operation in a standby state. The operation in the standby state is an operation of causing the display unit 208 to function as the electronic viewfinder. Specifically, the system control unit 200 causes the shooting unit 30 to start shooting a moving image, and causes the image processing unit 205 to generate image data for live-view display.

In parallel with the live-view display operation, the system control unit 200 continuously executes AE processing and AF processing based on evaluation values generated by the image processing unit 205. As a result, image data for display in which the focus state and brightness have been adjusted is generated. The system control unit 200 displays an image based on the image data for display on the display unit 208 by controlling the display control unit 207.

In the shooting mode, the system control unit 200 waits for an operation on the execution button 51 while continuing the live-view display on the display unit 208. When an operation on the execution button 51 has been detected, the system control unit 200 records, for example, one frame of the image data for display as a still image into the recording medium 61. Alternatively, the system control unit 200 starts recording a live-view image (a moving image) into the recording medium 61. Whether to record a still image or record a moving image can be changed by an advance setting. In the case of the setting for recording a still image, the system control unit 200 records a still image each time an operation on the execution button 51 is detected. On the other hand, in the case of the setting for recording a moving image, the system control unit 200 repeats starting and stopping of recording of a moving image each time an operation on the execution button 51 is detected. In the shooting mode, measurement of a distance is not executed.

In the range finding mode, the system control unit 200 waits for an operation on the execution button 51 while continuing the live-view display on the display unit 208. Note that the system control unit 200 superimposes and displays an image of a cursor, a pointer, or the like indicating a ranging point at a predetermined position over live-view images in the range finding mode.

When an operation on the execution button 51 has been detected, the system control unit 200 executes a range finding operation. The system control unit 200 causes the light emitting element 21a to output pulsed laser light, and further enables (activates) the light receiving unit 22 and the distance computation unit 204, by controlling the light emission control unit 21b. Thereafter, once a measured distance has been received from the distance computation unit 204, the system control unit 200 superimposes and displays an image indicating the measured distance or measurement failure over a live-view image that is currently being displayed. After a predetermined period has elapsed, or when an operation on the execution button 51 has been detected, the system control unit 200 resumes the live-view display and waits for an operation on the execution button 51.

Note that when an operation on the execution button 51 has been detected, the system control unit 200 may stop updating of live-view images and continuously display a composite image in which an image indicating the measured distance or measurement failure is superimposed over a frame image at the time of the operation on the execution button 51 until the predetermined period elapses.

In the simultaneous recording mode, the system control unit 200 waits for an operation on the execution button 51 while continuing the live-view display on the display unit 208. Note that in the simultaneous recording mode, too, the system control unit 200 superimposes and displays an image of a cursor, a pointer, or the like indicating a ranging point at a predetermined position over live-view images, similarly to the case of the range finding mode.

When an operation on the execution button 51 has been detected, the system control unit 200 executes a range finding operation, similarly to the range finding mode. Furthermore, the system control unit 200 executes an operation of recording a still image or a moving image.

For example, when an operation on the execution button 51 has been detected, the system control unit 200 causes the image processing unit 205 to start generating moving image data for recording. Alternatively, when an operation on the execution button 51 has been detected, the system control unit 200 causes the image sensor 30b to suspend shooting of a moving image and execute shooting of a still image, and causes the image processing unit 205 to generate still image data for recording. The system control unit 200 stores the moving image data or still image data for recording generated by the image processing unit 205 into the memory 206.

Note that it has been assumed here that the moving image data or still image data for recording is newly generated. However, a moving image for live-view display may be recorded, or one frame of a moving image for live-view display may be recorded as a still image.

Thereafter, once a ranging result (i.e., a measured distance or measurement failure) has been received from the distance computation unit 204, the system control unit 200 superimposes an image indicating the ranging result over live-view images. As a result, the ranging result is superimposed and displayed over live-view display. Furthermore, only in a case where ranging has been successful, the system control unit 200 records the moving image data or still image data for recording stored in the memory 206, as well as the measured distance, into the recording medium 61 in association with each other (the details will be described later). In a case where a result indicating a ranging failure has been received from the distance computation unit 204, the system control unit 200 discards the image data stored in the memory 206 without recording the same into the recording medium 61.

Note that in moving image data and still image data, information that is recorded on general digital cameras, such as information related to the date and time of shooting and the settings at the time of shooting, is recorded in a file header, for example. The measured distance may also be recorded similarly in the file header, or may be recorded as a separate file. In a case where the measured distance is recorded as a separate file, in order to make it apparent that an image data file and a distance information file are associated with each other, the files are recorded in such a manner that the same character string is included in the file names, for example.

Each time the mode switching button 53 is operated, the system control unit 200 switches among the operation modes in a sequential order. Alternatively, when the mode switching button 53 has been operated, the system control unit 200 may display a screen of the list of the operation modes, and switch to the operation mode that has been selected by the user from the screen of the list. Although no limitation is placed on a selection method, the selection may be made by, for example, an operation on the direction key included in the operation unit 50. Note that it is also permissible to superimpose and display characters, an icon, or the like indicating the current operation mode over live-view images, or change the color of light emitted by an LED or the like provided in the range finding device 100 to the color corresponding to the current operation mode.

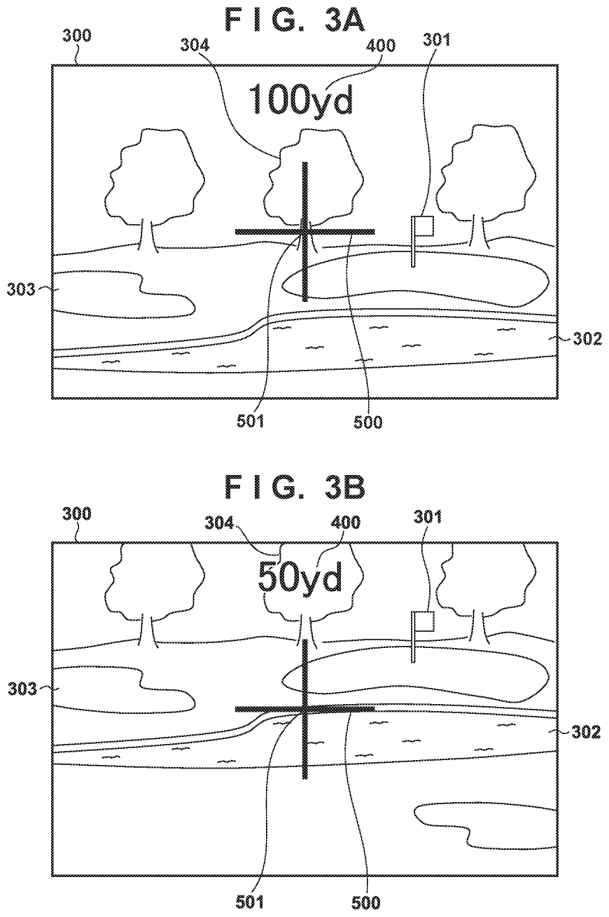

FIGS. 3A and 3B show examples of images that are displayed after ranging in the range finding mode or the simultaneous recording mode. Here, a case where the range finding device 100 is used on a golf course is assumed, and a captured image 300 obtained by the shooting unit 30 shows a flag 301, a pond 302, a bunker 303, trees 304, and so forth. FIG. 3A shows a case where the distance to the tree 304 has been measured, whereas FIG. 3B shows a case where the distance to the edge of the pond 302 has been measured.

As descried above, in an operation mode in which ranging is executed via an operation on the execution button 51, an index indicating a ranging position is superimposed and displayed over live-view images. Although FIGS. 3A and 3B exemplarily show a cross-shaped cursor 500 as the index indicating the ranging position, another form of index, such as a dot-like image and an arrow-like image, may be used.

The cursor 500 is superimposed so that an intersection 501 thereof is located at a predetermined position in the captured image 300, which is the center of the captured image 300 in the present case. The range finding unit 20 has been adjusted to output laser light toward a position which is within the field of view of the shooting unit 30 and which corresponds to the intersection 501 of the cursor 500. Therefore, the user can measure the distance to a desired position by operating the execution button 51 after adjusting the direction of the range finding device 100 so as to make the intersection 501 of the cursor 500 coincide with the position for which the user wants to perform ranging.

In a case where distance measurement has been performed normally, an image 400 indicating the measured distance is superimposed and displayed as a measurement result over live-view images. Note that in a case where the distance measurement has failed, an image of characters or a message indicating that the measurement has failed, such as “Error”, “ ×”, and “Measurement has failed”, is superimposed and displayed in place of the distance.

Although FIGS. 3A and 3B show the distance in yards as the use on the golf course is assumed, it is also permissible to configure a setting that displays the distance using another unit, such as meters.

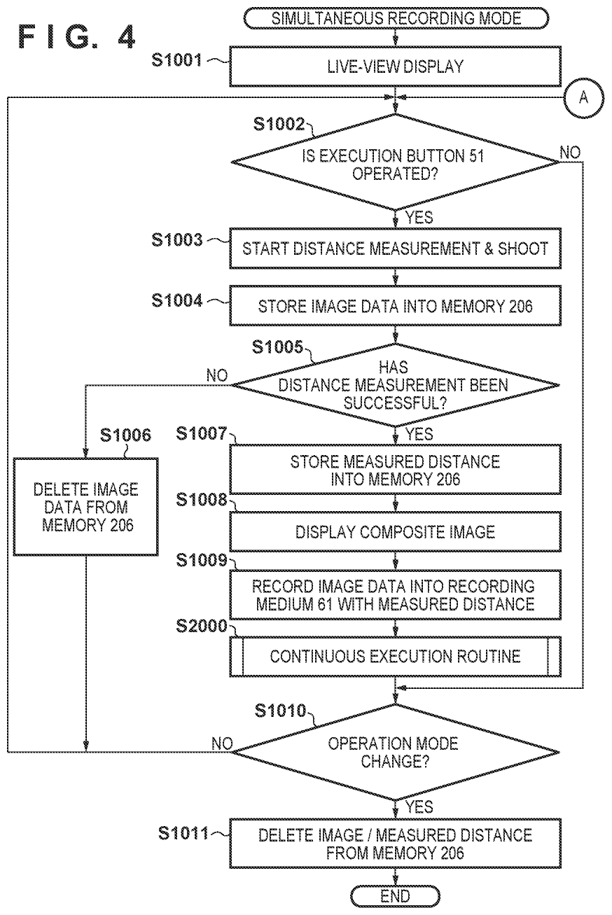

FIG. 4 is a flowchart related to the operations in the simultaneous recording mode of the range finding device 100. The operations shown in the flowchart are realized by the system control unit 200 executing a program stored in the nonvolatile memory 201 and controlling the operations of each component. The operations of the flowchart shown in FIG. 4 are executed from a time point when the simultaneous recording mode has been selected by the mode switching button 53 while the power of the range finding device 100 is ON.

In step S1001, in order to cause the display unit 208 to function as the electronic viewfinder, the system control unit 200 causes each component to execute the operations that are necessary for live-view display. The system control unit 200 causes the shooting unit 30 to continuously shoot a moving image at a predetermined frame rate. Furthermore, the system control unit 200 causes the image processing unit 205 to generate image data for display on a per-frame basis, and also to generate evaluation values for AE and AF. The system control unit 200 executes AE processing and AF processing based on the evaluation values.

The system control unit 200 stores image data for display corresponding to one frame, which has been generated by the image processing unit 205, into the video memory region of the memory 206. Furthermore, the system control unit 200 composites an image of an index indicating a ranging position (the cursor 500 in FIGS. 3A and 3B) with the image data inside the video memory. Note that an image indicating other types of information, such as an image indicating a remaining battery level or an operation mode, may also be composited in a similar manner. Moreover, the system control unit 200 controls the display control unit 207 so that the display unit 208 performs display based on composite image data stored in the video memory region of the memory 206. The system control unit 200 repeatedly executes the foregoing operations on a per-frame basis, thereby realizing live-view display on the display unit 208.

In step S1002, the system control unit 200 determines whether the execution button 51 has been operated; step S1003 is executed when it is determined that the execution button 51 has been operated, and step S1010 is executed when it is not thus determined.

In step S1003, in order to measure a distance, the system control unit 200 causes, by controlling the light emission control unit 21b, the light emitting element 21a to output pulsed laser light, and also enables (activates) the light receiving unit 22 and the distance computation unit 204. Note that as stated earlier, the system control unit 200 may stop updating of live-view images in step S1003. In this case, a frame image at the time of the operation on the execution button 51 is continuously displayed on the display unit 208.

Furthermore, the system control unit 200 causes the shooting unit 30 to shoot a still image or a moving image for recording. Note that AE processing and AF processing at the time of shooting of the still image are executed by the system control unit 200 based on the evaluation values that have been generated by the image processing unit 205 in relation to the live-view images. The system control unit 200 also instructs the image processing unit 205 to generate image data for recording.

In step S1004, the system control unit 200 stores the image data for recording generated by the image processing unit 205 into the memory 206. Note that in a case where a moving image is recorded, the system control unit 200 continuously stores image data into the memory 206 until a ranging result is received from the distance computation unit 204.

In step S1005, the system control unit 200 determines whether the distance measurement has been successful based on the ranging result obtained from the distance computation unit 204. The system control unit 200 executes step S1007 when it is determined that the distance measurement has been successful, and executes step S1006 when it is not thus determined.

In step S1006, the system control unit 200 deletes the image data for recording that was temporarily stored into the memory 206 in step S1004. That is to say, the image data for recording that was generated (through successful shooting) via AF and AE processing in step S1003 is deleted without being recorded. Thereafter, the system control unit 200 executes step S1002.

In step S1007, the system control unit 200 stores the measured distance into the memory 206.

In step S1008, the system control unit 200 composites an image indicating the measured distance (the image 400 of FIGS. 3A and 3B) with the frame image at the time of the operation on the execution button 51, which is stored in the video memory region of the memory 206. As a result, an image over which the cursor 500 and the image 400 indicating the distance is displayed on the display unit 208 as shown in FIGS. 3A and 3B.

Note that in order to simplify processing, it has been assumed here that an image indicating the distance is composited with a live-view image at the time of the operation on the execution button 51, and the result of the composition is displayed. However, it is also permissible to generate composite image data by compositing the cursor 500 and the image 400 indicating the distance with the image data for recording stored in the memory 206, perform scaling with respect to the composite image data, and then display the composite image data on the display unit 208.

In step S1009, the system control unit 200 records the image data for recording that was stored into the memory 206 in step S1004, as well as the measured distance that was stored into the memory 206 in step S1007, into the recording medium 61 in association with each other.

Note that the measured distance may be recorded in a state where it has been composited, as an image indicating the distance, with the image data for recording, or may be recorded in a state where it is included, as a numerical value indicating the distance, in metadata to be recorded in a data file that stores the image data for recording. Both types of recording may be used in combination. Note that in a case where the measured distance is recorded as an image, the index indicating the ranging position (the cursor 500) is also composited with the image data for recording. In a case where a moving image is recorded, the measured distance and the cursor are composited with each frame. Note that the ranging position (coordinates) within the image may also be recorded as metadata; however, in a case where reproduction is performed on the range finding device 100, as the ranging position within the image is known (the center of the image), the ranging position may not be recorded.

Also note that in a case where the measured distance is recorded only as a numerical value (distance data), when the image data for recording is reproduced and displayed, the system control unit 200 obtains the distance data from the metadata, converts the distance data into the image 400, and displays the same in a state where it has been composited with the image data together with the cursor 500.

As described above, in the simultaneous recording mode, image data is recorded on the condition that the measurement has been successful. This can suppress wasteful consumption of the capacity of the recording medium 61, or display of unnecessary images during reproduction of image data recorded in the recording medium 61, caused by recording of image data of a case where the measurement has failed. Furthermore, the trouble of looking for image data corresponding to successful measurement from image data recorded in the recording medium 61 can be saved.

Step S2000 is processing for a case where the execution button 51 has been operated again within a predetermined period since the execution button 51 was operated in step S1002 (a continuous execution routine). Step S2000 will be described later.

In step S1010, the system control unit 200 determines whether the operation mode has been changed. The system control unit 200 regards not only an operation on the mode switching button 53, but also power-OFF via the power source button 52, as a change in the operation mode. The system control unit 200 executes step S1011 when it is determined that the operation mode has been changed, and executes step S1002 when it is not thus determined.

In step S1011, the system control unit 200 deletes the image data for recording and the measured distance that are left in the memory 206, and ends the operations of the simultaneous recording mode.

Note that each process shown in FIG. 4 need not necessarily be executed in the order shown in FIG. 4. For example, steps S1008 and S1009 may be executed in a reverse order, or may be executed in parallel.

As described above, in the present embodiment, recording is performed only in a case where the measurement has been successful in the simultaneous recording mode. This can suppress recording of images that are not accompanied by significant measured distances, which can occur in a case where recording is performed regardless of whether the measurement has been successful or has failed. As a result, accumulation of images that are unnecessary for the user in the recording medium 61, as well as the occurrence of the trouble of looking for necessary images, can be suppressed. That is to say, captured images that correspond to measured distances can be efficiently confirmed.

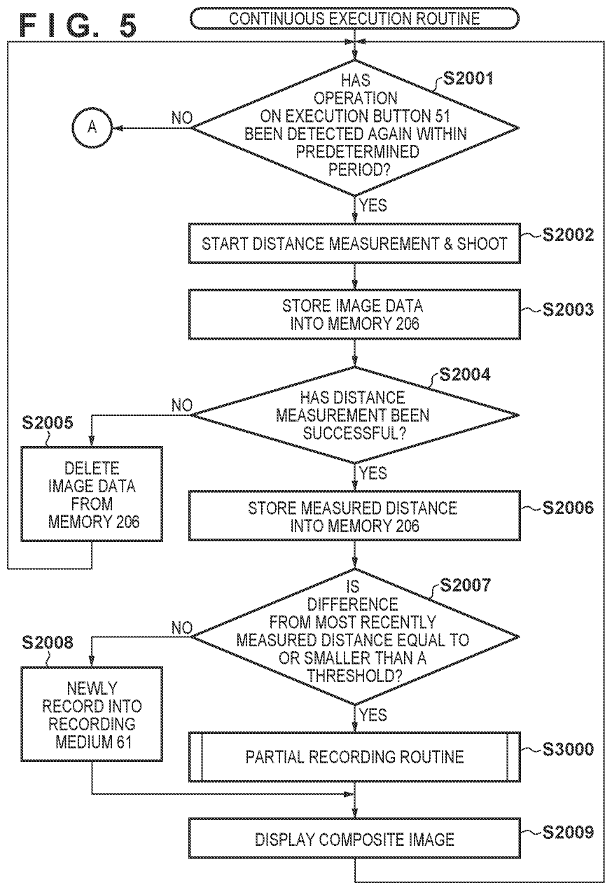

Next, the continuous-execution routine in step S2000 will be described using a flowchart of FIG. 5. Note that the operations shown in the flowchart are realized by the system control unit 200 executing a program stored in the nonvolatile memory 201 and controlling the operations of each component.

In step S2001, the system control unit 200 determines whether an operation on the execution button 51 has been detected within a predetermined period since the most recent detection of an operation on the execution button 51. The system control unit 200 executes step S2002 when it is determined that an operation on the execution button 51 has been detected within the predetermined period since the most recent detection of an operation on the execution button 51. On the other hand, the system control unit 200 executes step S1002 when it is not determined that an operation on the execution button 51 has been detected within the predetermined period since the most recent detection of an operation on the execution button 51.

The system control unit 200 treats a plurality of operations that have been performed on the execution button 51 at an interval equal to or shorter than the predetermined period as one set of measurements, as with the operations that have been intended for re-measurement targeting the same position as the previous position or nearby positions. No limitation is intended regarding the predetermined period; the predetermined period can be changed by the user, and may be, for example, three to four seconds.

As steps S2002 to S2006 are processing similar to steps S1003 to S1007 of FIG. 4, a description thereof is omitted. However, after executing step S2005, the system control unit 200 executes S2001 in place of step S1002.

In step S2007, the system control unit 200 determines whether the absolute value of the difference between a distance d1 measured in step S2002 and a distance d0 that was measured most recently before S2002 (|d0−d1|) is equal to or smaller than a threshold. The system control unit 200 executes step S3000 when it is determined that the difference is equal to or smaller than the threshold, and executes step S2008 when it is not thus determined. Note that the threshold of step S2002 can be preset as a value for determining that there is no significant difference between the two distances. Note that in place of the difference between the distances, the absolute value of the difference between the distance ratio and one (|1−d0/d1|) may be used.

In step S2008, the system control unit 200 records the image data for recording that was stored into the memory 206 in step S2003, as well as the measured distance that was stored into the memory 206 in step S2006, into the recording medium 61 in association with each other. Thereafter, the system control unit 200 executes step S2009.

Step S3000 is processing in which, among the plurality of measured distances which have been obtained continuously at the interval equal to or shorter than the predetermined period and which do not have a significant difference from one another, a single measured distance that satisfies a preset condition is recorded into the recording medium 61 together with corresponding image data for recording. The preset condition may be, for example, a condition such as “recording is performed with respect to the first single ranging”, “recording is performed with respect to the latest single ranging”, and “recording is performed with respect to a single ranging with the smallest amount of image blur in the captured image”, and a plurality of conditions may be combined. These conditions can be set by the user in advance. Furthermore, although it is assumed here that recording is performed only once, a setting where recording is performed predetermined multiple times with respect to one condition may be configurable.

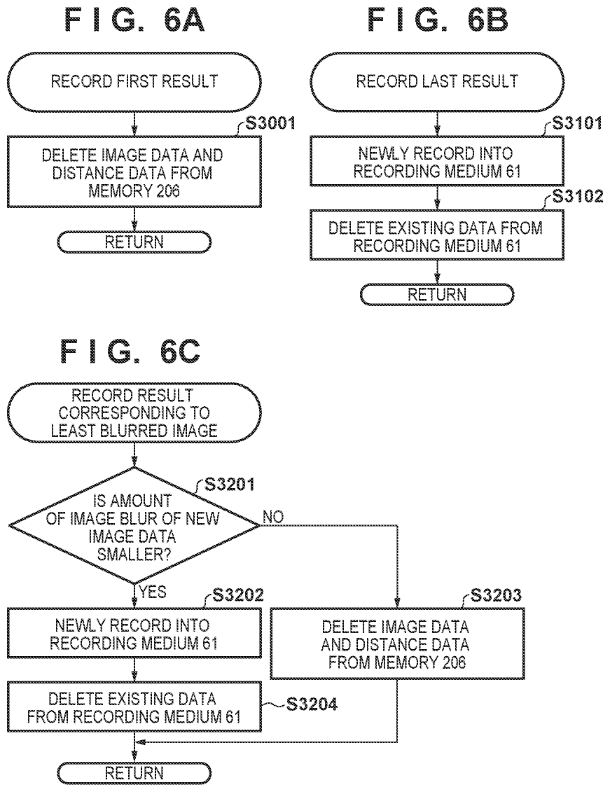

FIGS. 6A to 6C are flowcharts related to the operations that respectively correspond to the three conditions that have been exemplarily described, which are executed by the system control unit 200 in step S3000. The operations shown in the flowcharts are realized by the system control unit 200 executing a program stored in the nonvolatile memory 201 and controlling the operations of each component.

FIG. 6A shows a case where the condition that “recording is performed with respect to the first single ranging” has been set.

In this case, in step S3001, the system control unit 200 deletes the image data that was stored in step S2003 and the measured distance that was stored in step S2006 from the memory 206, and ends processing corresponding to the condition. In the case where the condition that “recording is performed with respect to the first single ranging” has been set, the image data and the measured distance that were recorded into the recording medium 61 in step S1009 are retained. The plurality of measured distances which have been obtained continuously at the interval equal to or shorter than the predetermined period since an operation on the execution button 51 was detected in step S1002 and which do not have a significant difference from one another, as well as corresponding image data, are not recorded in step S3000.

FIG. 6B shows a case where the condition that “recording is performed with respect to the latest single ranging” has been set.

In this case, in step S3101, the system control unit 200 reads out, from the memory 206, the image data that was stored in step S2003 and the measured distance that was stored in step S2006, and records them into the recording medium 61 similarly to step S1009.

Then, in step S3102, the image data and the measured distance that had already been recorded are deleted from the recording medium 61, and processing corresponding to the condition is ended. Note that step S3102 may be executed before step S3101. In a case where the condition that “recording is performed with respect to the latest single ranging” has been set, the image data and the measured distance that have been stored into the memory 206 most recently in steps S2003 and S2006 are recorded into the recording medium 61 in the form of overwriting. Among the plurality of measured distances which have been obtained continuously at the interval equal to or shorter than the predetermined period since an operation on the execution button 51 was detected in step S1002 and which do not have a significant difference from one another, the measured distance that was obtained last is recorded in step S3000 together with corresponding image data. The measured distance that was obtained earlier and corresponding image data are deleted.

FIG. 6C shows a case where the condition that “recording is performed with respect to a single ranging with the smallest amount of image blur in the captured image” has been set.

In this case, in step S3201, the system control unit 200 compares the amount of image blur in image data that was stored into the memory 206 in step S2003 that was executed most recently (new image data) with the amount of image blur in image data that was stored into the memory 206 therebefore (old image data). The old image data is image data that was recorded into the recording medium 61 in step S1009, or image data that was stored into the memory 206 in immediately preceding step S2003.

Here, the system control unit 200 determines whether the amount of image blur in the image of the new image data is smaller than that in the image of the old image data. The system control unit 200 executes step S3202 when it is determined that the amount of image blur in the image of the new image data is smaller than that in the image of the old image data, and executes step S3203 when it is not thus determined.

Note that the system control unit 200 can obtain, for example, the distribution of spatial frequencies in the pieces of image data with use of the image processing unit 205, and determine that the amount of image blur is smaller in the image data including more high-frequency components. Note that the determination may be made using another method.

In step S3202, the system control unit 200 reads out, from the memory 206, the image data and the measured distance that were stored into the memory 206 in steps S2003 and S2006 that were executed most recently, and records them into the recording medium 61 similarly to step S1009.

Then, in step S3204, the system control unit 200 deletes the image data and the measured distance that were recorded in the recording medium 61 before the execution of step S3202, and ends processing corresponding to the condition. Note that the image data and the measured distance to be deleted are the image data and the measured distance that are newest next to the image data and the measured distance that were recorded in step S3202.

In step S3203, the system control unit 200 deletes, from the memory 206, the image data and the measured distance that were stored into the memory 206 in steps S2003 and S2006 that were executed most recently, and ends processing corresponding to the condition.

Returning to FIG. 5, in step S2009, the system control unit 200 causes the display unit 208 to display the image data that has been newly recorded in step S3000 or S2008, similarly to step S1008. In a case where step S3000 has been executed and the condition that “recording is performed with respect to the first single ranging” has been set, display need not be performed again in step S2009.

As described above, according to the present embodiment, in a case where a range finding device with an image capture function has been set to record an image that is shot at the time of ranging, image data and a measured distance are recorded on the condition that the ranging has been successful. This can suppress recording of image data associated with a meaningless measured distance. Therefore, when the user attempts to confirm a measured distance by reproducing recorded image data on the range finding device, there is no need for the user to look for image data associated with significant distance information.

Furthermore, in some cases, ranging is continuously executed multiple times with respect to the same position, or nearby positions, for the purpose of improving the reliability of a measured distance or confirming a measured distance. According to the present embodiment, in a case where ranging has been continuously executed in this way, only a part of a plurality of measured distances that do not have a significant difference from one another is recorded together with image data. Therefore, the measured distances that are identical to one another or are barely different from one another need not be confirmed many times, and the measured distances can be confirmed efficiently.

### Other Embodiments

The above has described a mode in which the present invention is implemented on a range finding device with an image capture function. However, the present invention may be implemented on an image capture apparatus and an electronic device with a range finding function that operate in coordination with each other. Furthermore, a part of the operations described in the above-described embodiment (e.g., the continuous execution routine of step S2000) may be skipped.

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-116576, filed on Jul. 21, 2022, which is hereby incorporated by reference herein in its entirety.

What is claimed is:

1. A range finding device, comprising:
an image sensor;
a measurement circuit that measures a distance to a predetermined position within a field of view of the image sensor based on time of flight of light; and
a control circuit that records image data that has been obtained using the image sensor, as well as a measurement result from the measurement circuit, into a recording medium in association with each other,
wherein the control circuit executes the recording under a condition that the measurement performed by the measurement circuit has been successful.

2. The range finding device according to claim 1, wherein
the control circuit records a part of a plurality of measurement results that have been continuously obtained by the measurement circuit.

3. The range finding device according to claim 2, wherein
among the plurality of measurement results, the control circuit records one or more measurement results that have been obtained first.

4. The range finding device according to claim 2, wherein
among the plurality of measurement results, the control circuit records one or more measurement results that have been obtained last.

5. The range finding device according to claim 2, wherein
among the plurality of measurement results, the control circuit records a single measurement result corresponding to image data with the smallest amount of image blur.

6. The range finding device according to claim 2, wherein
the plurality of measurement results are measurement results of which differences are not greater than a threshold.

7. The range finding device according to claim 1, wherein
the control circuit associates the measurement result with the image data so that the measurement result is superimposed as an image.

8. The range finding device according to claim 1, wherein
the control circuit includes the measurement result into metadata of the image data.

9. A range finding device, comprising:
an image capture device including an image capture optical system and an image sensor;
a measurement circuit that measures a distance to a predetermined position within a field of view of the image capture device;
a focus adjustment circuit that performs focus adjustment with respect to the image capture optical system; and
a control circuit that records image data that has been obtained using the image capture device, as well as a measurement result from the measurement circuit, into a recording medium in association with each other,
wherein
the control circuit executes the recording under a condition that the measurement performed by the measurement circuit has been successful, and
in a case where the measurement performed by the measurement circuit has not been successful, the recording is not executed even if the focus adjustment has been successful.

10. A control method for a range finding device that includes an image sensor and a measurement circuit that measures a distance to a predetermined position within a field of view of the image sensor based on time of flight of light, the control method comprising
recording image data that has been obtained using the image sensor, as well as a measurement result from the measurement circuit, into a recording medium in association with each other under a condition that the measurement performed by the measurement circuit has been successful.

11. A control method for a range finding device that includes an image capture device including an image capture optical system and an image sensor, a measurement circuit that measures a distance to a predetermined position within a field of view of the image capture device, and a focus adjustment circuit that performs focus adjustment with respect to the image capture optical system, the control method comprising:
recording image data that has been obtained using the image capture device, as well as a measurement result from the measurement circuit, into a recording medium in association with each other under a condition that the measurement performed by the measurement circuit has been successful; and
in a case where the measurement performed by the measurement circuit has not been successful, refraining from executing the recording even if the focus adjustment has been successful.

12. A non-transitory computer-readable medium storing a program executable by a computer being included in a range finding device that comprises an image sensor and a measurement circuit that measures a distance to a predetermined position within a field of view of the image sensor based on time of flight of light, wherein the program causes, when executed by the computer, the computer to record image data that has been obtained using the image sensor, as well as a measurement result from the measurement circuit, into a recording medium in association with each other under a condition that the measurement performed by the measurement circuit has been successful.

13. A non-transitory computer-readable medium storing a program executable by a computer being included in a range finding device that includes an image capture device including an image capture optical system and an image sensor, a measurement circuit that measures a distance to a predetermined position within a field of view of the image capture device, and a focus adjustment circuit that performs focus adjustment with respect to the image capture optical system, wherein the program causes, when executed by the computer, the computer to perform a control method for the range finding device comprising:
recording image data that has been obtained using the image capture device, as well as a measurement result from the measurement circuit, into a recording medium in association with each other under a condition that the measurement performed by the measurement circuit has been successful; and
in a case where the measurement performed by the measurement circuit has not been successful, refraining from executing the recording even if the focus adjustment has been successful.
